(19) United States
(12) Patent Application Publication
(10) Pub. No.: US 2018/0316789 A1
(43) Pub. Date: Nov. 1, 2018

(54) AUTOMATED SMS REGRESSION AND FUNCTIONAL TESTING

(71) Applicant: Cyara Solutions Pty Ltd, Hawthorn (AU)

(72) Inventor: Gavin Sansom, Lisarow (AU)

(21) Appl. No.: 15/614,619

(22) Filed: Jun. 6, 2017

Related U.S. Application Data
(60) Provisional application No. 62/491,254, filed on Apr. 28, 2017.

(51) Int. Cl. H04M 3/32; H04M 7/00; H04M 3/51

(52) U.S. Cl. CPC H04M 3/323; H04M 2203/056; H04M 3/5183; H04M 7/0048

(57) ABSTRACT

A system and method for automated SMS regression and functional testing, that receives SMS-based messages from a contact center, validates that the received message text is correct, and when necessary replies to the message with an appropriate response. This system may be deployed alongside production (customer-facing) operations, and used in-place with existing contact center systems by configuring the appropriate destination numbers for testing and optionally allowing test cases through an existing firewall (depending on a particular arrangement).

### CROSS-REFERENCE TO RELATED APPLICATIONS

The present application also claims the benefit of, and priority to, U.S. provisional patent application Ser. No. 62/491,254, titled “AUTOMATED SMS REGRESSION AND FUNCTIONAL TESTING”, and filed on Apr. 28, 2017, the entire specification of which is incorporated herein by reference in its entirety.

### BACKGROUND OF THE INVENTION

### Field of the Art

The disclosure relates to the field of contact center operations, and more particularly to the field of testing for methods for SMS communication systems.

### Discussion of the State of the Art

In the field of contact center operations, customer experience may be improved by enabling additional communication channels to facilitate a more convenient and familiar interaction experience. A common communication channel is text messaging via user mobile devices, using short message service (SMS) communication. Messages may be sent to customers according to automated configuration, providing notifications such as service messages, account notifications, or billing reminders, and two-way messaging may be provided such as to request feedback from a user or to enable SMS-based interactions with automated systems for self-service support options.

With SMS messaging, it is important to ensure that customers receive messages, as well as to ensure they receive the correct messages. Manual testing may be performed using mobile devices, but this is labor-intensive and ultimately inefficient from a contact center operations standpoint.

What is needed is a means to automate SMS regression and functional testing, to enable an automated case-based testing approach that can test message receipt and validity, as well as test two-way SMS interactions by communicating with a contact center's SMS gateway.

### SUMMARY OF THE INVENTION

Accordingly, the inventor has conceived and reduced to practice, in a preferred embodiment of the invention, a system and method for automated SMS regression and functional testing.

The invention comprises a system that receives SMS-based messages from a contact center, validates that the received message text is correct, and when necessary replies to the message with an appropriate response. This system may be deployed alongside production (customer-facing) operations, and used in-place with existing contact center systems by configuring the appropriate destination numbers for testing and optionally allowing test cases through an existing firewall (depending on a particular arrangement).

According to a preferred embodiment of the invention, a system for automated SMS regression and functional testing, comprising: a test database configured to store and provide testing information, the testing information comprising at least a test configuration, each test case configuration comprising at least a plurality of SMS message information and an execution configuration; a test case management server configured to retrieve testing information from the test database and compare at least a plurality of SMS messages against at least a portion of the SMS message information of a test case configuration; and a messaging server configured to receive at least a plurality of SMS messages via a network, provide at least a portion of an SMS message to the test case management server, and produce and transmit at least an SMS message to an SMS gateway via the network, is disclosed.

According to another preferred embodiment of the invention, a method for automated SMS regression and functional testing, comprising the steps of: receiving, at a messaging server configured to receive at least a plurality of SMS messages via a network, provide at least a portion of an SMS message to the test case management server, and produce and transmit at least an SMS message to an SMS gateway via the network, an SMS message via a network; retrieving, using a test case management server configured to retrieve testing information from the test database and compare at least a plurality of SMS messages against at least a portion of the SMS message information of a test case configuration, a stored test case configuration from a test database configured to store and provide testing information, the testing information comprising at least a test configuration, each test case configuration comprising at least a plurality of SMS message information and an execution configuration; comparing at least a portion of the received SMS message against the stored test case configuration; and storing the results of comparison for future reference, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary system architecture for automated SMS regression and functional testing, according to a preferred embodiment of the invention.

FIG. 2 is a flow diagram illustrating an exemplary method for automated SMS regression and functional testing, illustrating a process for receiving, validating, and optionally responding to a text message, according to a preferred embodiment of the invention.

FIG. 3 is a flow diagram illustrating an exemplary method for automated SMS regression and functional testing, illustrating a process for a creating an SMS test case, according to a preferred embodiment of the invention.

FIG. 4 is a block diagram illustrating an exemplary hardware architecture of a computing device used in an embodiment of the invention.

FIG. 5 is a block diagram illustrating an exemplary logical architecture for a client device, according to an embodiment of the invention.

FIG. 6 is a block diagram showing an exemplary architectural arrangement of clients, servers, and external services, according to an embodiment of the invention.

FIG. 7 is another block diagram illustrating an exemplary hardware architecture of a computing device used in various embodiments of the invention.

### DETAILED DESCRIPTION

The inventor has conceived, and reduced to practice, in a preferred embodiment of the invention, a system and method for automated SMS regression and functional testing.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

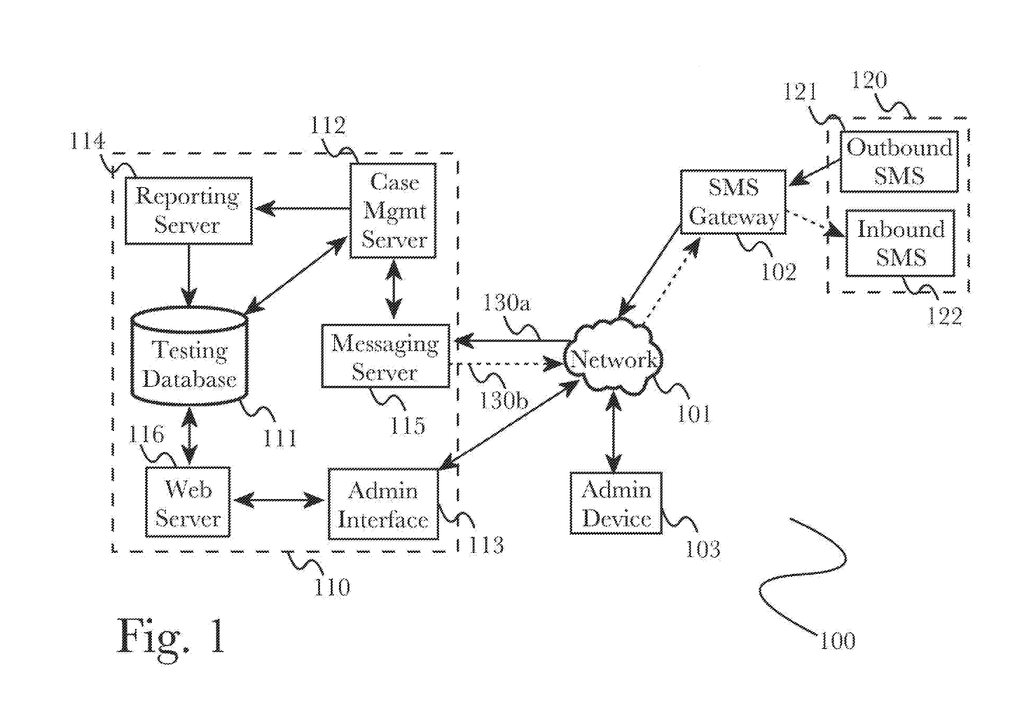

FIG. 1 is a block diagram illustrating an exemplary system architecture 100 for automated SMS regression and functional testing, according to a preferred embodiment of the invention. According to the embodiment, an SMS testing system 110 may comprise a testing database 111 that stores and provides case- and test-related information such as test case configuration and execution results, a case management server 112 that creates, stores, retrieves, and executes test cases, and a web server 116 that operates an administration interface 113 that comprises an interactive interface for configuring and directing SMS test cases via a network 101, for example from an administrator's computing device 103 such as a personal computer or mobile device. In this manner, an administrator may configure and execute test cases remotely and may monitor the operation or results of test case execution. Test case configuration may comprise a variety of message information such as (for example) including text information for message fields (such as the “subject” and “body” fields commonly used in email messages and sometimes utilized in SMS messaging), “to” and “from” addresses that may be used to verify the operation of specific source and destination addresses or to direct the routing of messages to and from those addresses, specific gateway information such as a server to be used for sending a message or a server to be targeted for message receipt, network information such as specific connections, addresses, carriers, frequency bands, network technologies, or bandwidth to be used during test case execution, timing information such as a specific minimum or maximum time to respond to a request or for overall execution of a test case or a “pulse” interval to determine test execution frequency and timing, or other message, system, or case-specific information. In this manner, the configuration and execution of a test case may be managed as precisely as needed to adequately test the desired features or components, and may be stored and retrieved as a complete test case for future use without having to repeat configuration and without the risk of any details being lost.

A reporting server 114 may be used to monitor test case execution and produce reports from execution results, for example including message fields (such as sender address, recipient address, header, body, and other data fields), test case execution time (for example, tracking min/max time thresholds during test execution), what systems were tested, or other data that may be useful for future review. Test case reports may be stored in testing database 111 and presented for review via an administration interface 113. Messaging server 115 may be used to send and receive SMS and other messages as directed by case management server 112 (for example, receiving SMS messages from a contact center's SMS gateway 102, replying to SMS messages, or receiving e-mail messages such as to receive messages via e-mail and then respond via e-mail or SMS, or other various arrangements and configurations), and may optionally be a messaging server used in contact center operations (that is, the messaging server may be operated by a contact center and be responsible for sending and receiving messages between agents and customers, in addition to any use for testing) or may be a separate messaging server used for testing purposes, such as to test the effects of a particular server or message configuration prior to implementing the configuration on production systems, or a server operated by a third party as a service (for example, to provide SMS testing to a plurality of client contact centers). According to the embodiment, messaging server 115 may receive inbound SMS or other message types 130a via network 101, such as SMS messages transmitted via an SMS gateway 102 from a contact center 120 operating an outbound SMS generator 121 (as may be used to produce and send SMS notifications to customer mobile devices, for example). Messaging server 115 may, when appropriate, produce and send an SMS response 130b to gateway 102, to be sent to an inbound SMS receiver 122 operated by the contact center, for example to test message responses or multi-message interactions such as (for example) responding to account notifications such as billing notifications, fraud alerts, usage alerts, or other such notifications that may prompt a customer to provide a response (such as to request further information or to acknowledge receipt, or to provide one of a number of responses to determine handling of a situation that prompted the alert, such as to verify transactions in a fraud warning or to apply usage restrictions based on a usage alert).

According to some arrangements, more than one messaging server 115 may be utilized, such as (for example) to send an email message from messaging server 115 to an external SMS gateway 102 operated by a remote host such as an SMS service provider, for example a cellular network carrier or mobile virtual network operator (MVNO), or a private gateway used by a particular contact center 120, as well as to enable the testing of multiple messaging servers for redundancy, as is often utilized in corporate environments to prevent downtime should any single email server experience difficulties. This may also be utilized to compare performance between multiple SMS gateways or networks, for example to determine the fastest or most reliable network or gateway to use for customer-facing SMS interactions.

### DETAILED DESCRIPTION OF EXEMPLARY EMBODIMENTS

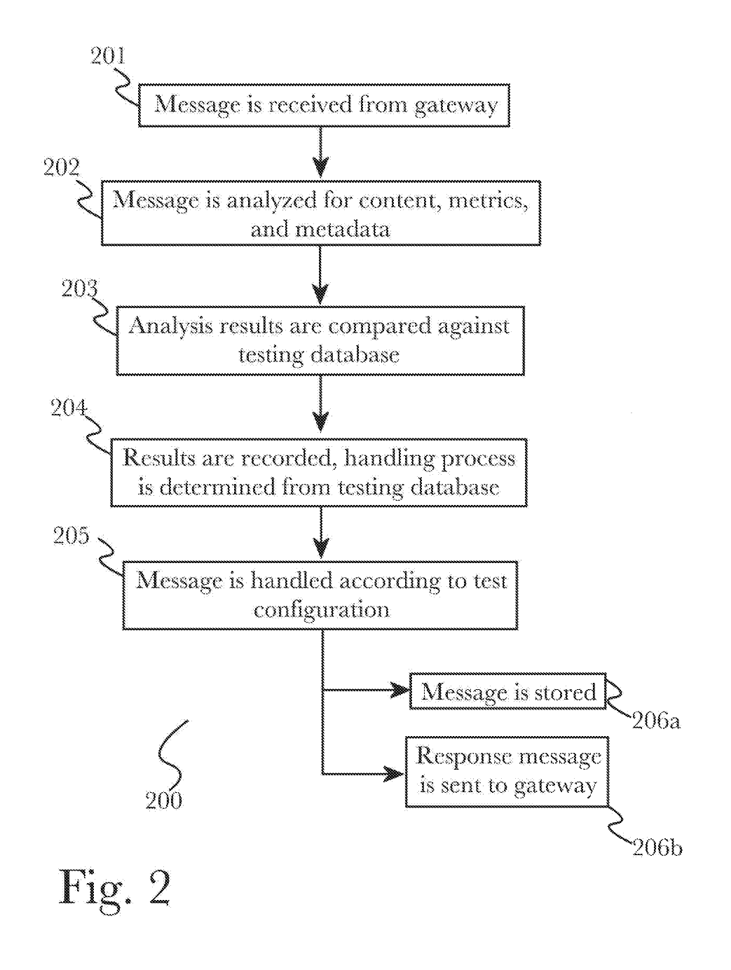

FIG. 2 is a flow diagram illustrating an exemplary method 200 for automated SMS regression and functional testing, illustrating a process for receiving, validating, and optionally responding to a text message, according to a preferred embodiment of the invention. In an initial step 201, a message may be received from an SMS gateway 115, for example an SMS message routed via a carrier network, or a message sent via e-mail (for example, a common function of SMS gateways is to receive messages via SMS and then retransmit those messages using e-mail, or vice-versa). The received message may then be analyzed 202 using automated text recognition to analyze the message's content, analysis of message delivery metrics such as timing information, and analysis of any contained metadata such as message headers or other message or test-specific information contained in or associated with the message. This information may be compared 203 against known testing information in a testing database 111 to determine the desired parameters and compare them to the actual parameters of the received message. For example, if messages are received that were sent according to a test case configuration, specific message information may be anticipated such as “to” and “from” fields or text content within the message, and when a message is received it may be compared against this predicted result to examine the execution of the test case and the operation of systems used during execution. Additionally, this comparison may be used to determine if a particular message is part of a test case (for example, to filter out errant messages such as spam that may be received), and if so which specific test case as multiple test cases may be executed or pending during a given span of time. According to the comparison results, the message delivery results may be recorded 204, such as to record performance of message delivery and timing information, or to record analysis results of the content of the message (for example, to determine that the text content of an SMS message corresponded with the desired content, or to ensure that an attachment was delivered without error or corruption), and the message may then be handled according to the test case configuration 205. Message handling may vary according to a particular test case and a particular message, but may include (for example, and not limited to) storing the message 206a for future reference alongside test results or for inclusion in a report produced by reporting server 114, or producing and transmitting a message response 206b to a gateway 115, for example to respond to a message as part of a multi-message test case with a plurality of receive-response iterative operations, or to forward a message for use in further testing by an additional gateway (that is, a gateway different than the one from which the message was received), or other such uses. Reporting server 114 may monitor and log operations and produce a report for a test case or a system that was tested, that may then be stored for future reference. For example, multiple test cases with varying configurations may be executed to thoroughly test a particular messaging server, gateway, or network connection, and the execution of these test cases may be logged as a testing report on the operation of the system(s) in question, optionally in addition to a plurality of testing reports for the specific test cases that were executed.

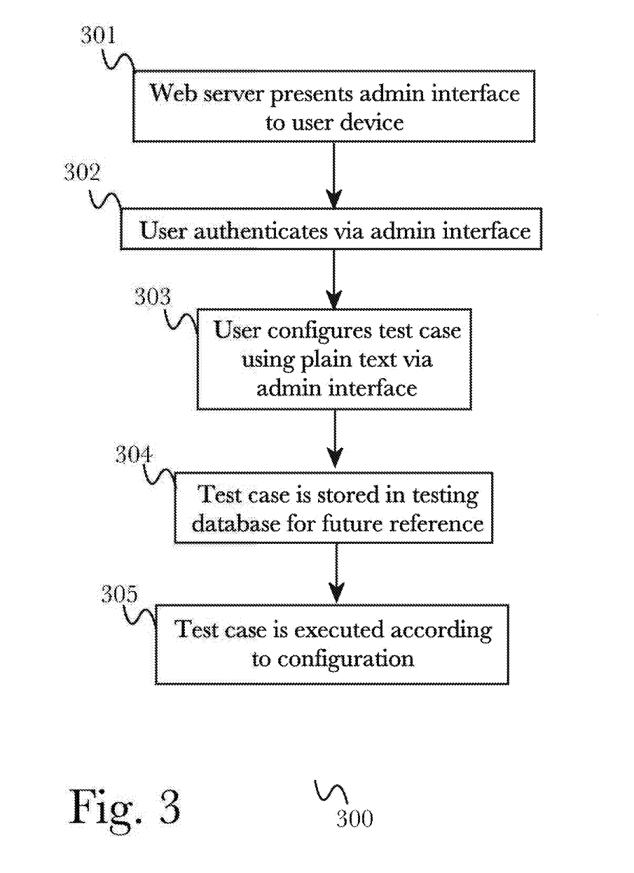

FIG. 3 is a flow diagram illustrating an exemplary method 300 for automated SMS regression and functional testing, illustrating a process for a creating an SMS test case, according to a preferred embodiment of the invention. In an initial step 301, a user may access an administration interface 113 via their device (for example, using a web browser on a personal computer or mobile device), and may authenticate in a next step 302 so they can interact as an administrator. In a next step 303, the authenticated user may configure a new test case using plain text, facilitating an easy-to-use means for designing test cases without the need for specialized training or advanced programming knowledge. For example, administration interface 113 may present a number of prompts or fields to configure specific features of an email test case, such as to fill out “to” and “from” fields for messages sent during execution, or to configure monitoring or reporting settings for a reporting server 114 to track execution of the test case. Additionally, for SMS testing, various communication channel parameters may be selected and configured for a test case. These may include (but are not limited to) selecting particular SMS gateways for use, configuring specific mobile numbers to be used in testing (both for source and destination fields), or specific message contents such as keywords or phrases, or scripted messages that should be sent and analyzed in their entirety (for example, to test the receipt of preprogrammed messages such as service notifications or automated responses). In a next step 304, the user may save the new test case and it is stored in testing database 111 for future reference, and in a next step 305 the saved test case may be retrieved and executed according to the configuration (for example, if the test case is configured to execute at a specific time or in response to a trigger such as a change in messaging server 115 configuration, as well as time-based execution parameters such as using response time thresholds to determine the success or failure of a test step). In some arrangements, a user may be able to manually execute a test case, such as for one-time testing of a specific feature or configuration.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

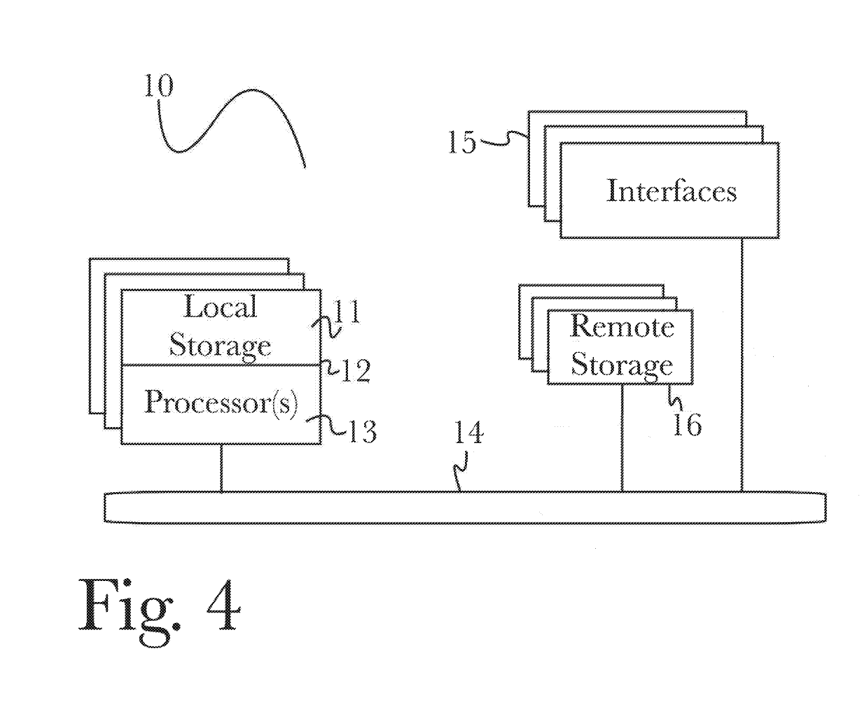

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

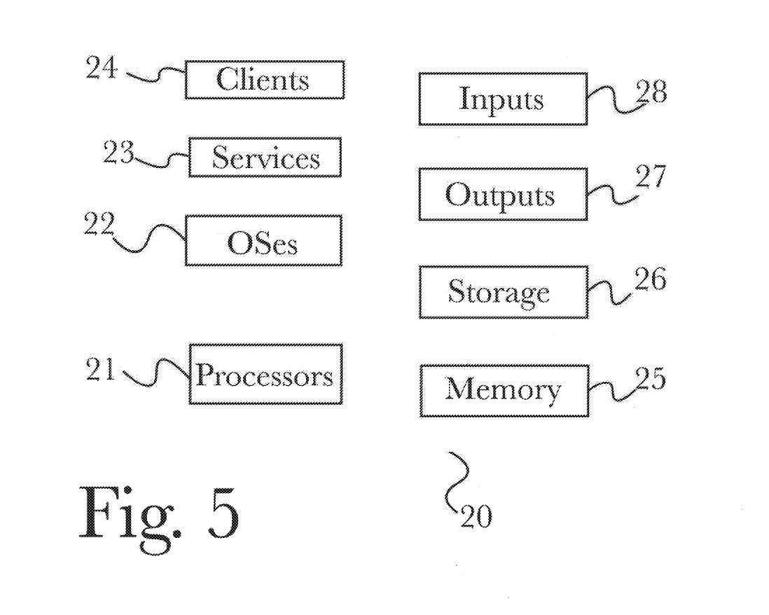

In some embodiments, systems according to the present invention may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

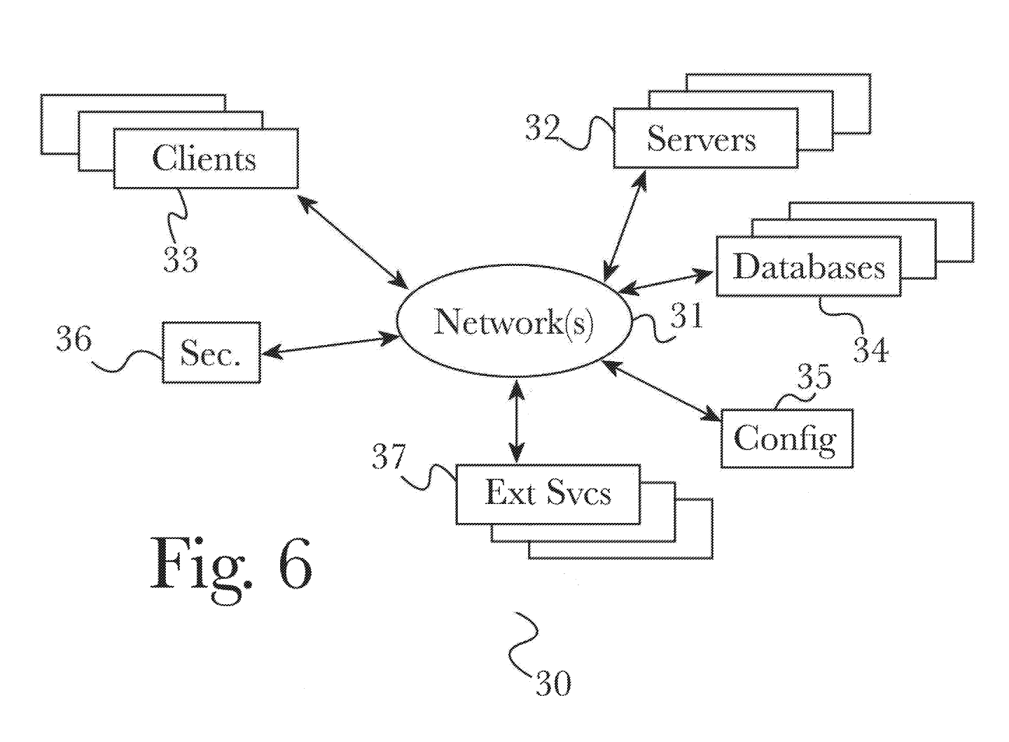

In some embodiments, systems of the present invention may be implemented on a distributed computing network, such as one having any number of clients and/or servers. Referring now to FIG. 6, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

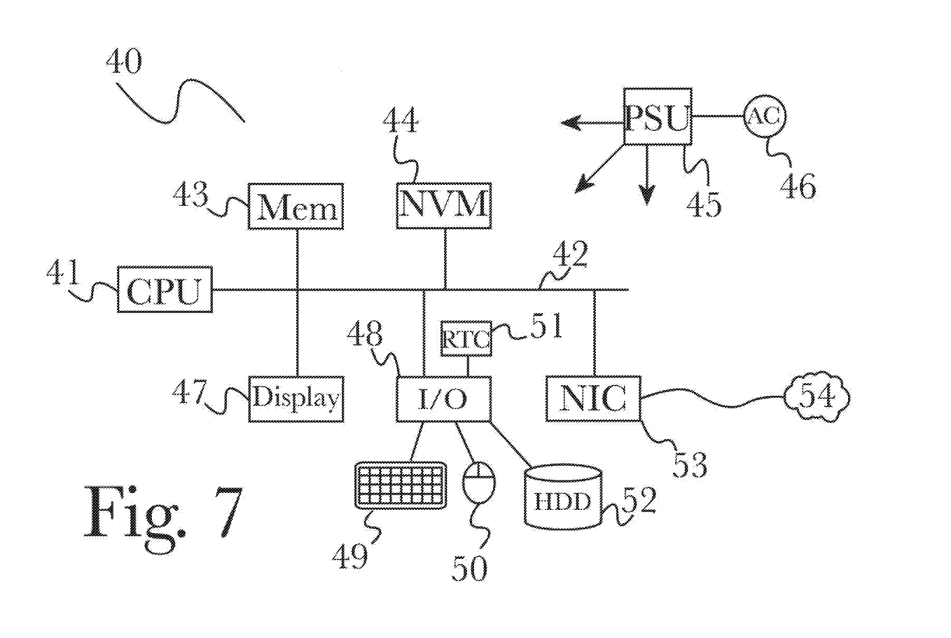

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

1. A system for automated SMS regression and functional testing, comprising:
a test database configured to store and provide testing information, the testing information comprising at least a test case configuration, each test case configuration comprising at least a plurality of SMS message information and an execution configuration, wherein the plurality of SMS message information comprises at least a selection of message text content;
a test case management server configured to retrieve testing information from the test database, analyze a subset of each of the text content and metadata contained within any portion of a text field of an SMS message, compare results of the analysis against at least a portion of the SMS message information of a test case configuration, and store message delivery results in the test database, the message delivery results comprising the results of comparison and a plurality of message delivery metrics comprising at least delivery timing, and configured to determine execution results comprising information pertaining to whether a test executed successfully as well as information identifying a test case with which the test was associated, the execution results being based on the comparison; and
a messaging server configured to receive at least a plurality of SMS messages via a network, provide at least a portion of an SMS message to the test case management server, and produce and transmit at least an SMS message to an SMS gateway via the network.

2. The system of claim 1, wherein the test case management server further comprises a user interface configured to present information and receive user interaction, wherein the test case management server directs the operation of the messaging server based at least in part on the received user interaction.

3. The system of claim 2, wherein the presented information comprises at least a portion of the testing information.

4. The system of claim 2, wherein the presented information comprises at least a portion of the SMS messages received.

5. A method for automated SMS regression and functional testing,
comprising the steps of:
receiving, at a messaging server configured to receive at least a plurality of SMS messages via a network, provide at least a portion of an SMS message to the test case management server, and produce and transmit at least an SMS message to an SMS gateway via the network, an SMS message via a network;
retrieving, using a test case management server configured to retrieve testing information from the test database and compare a subset of each of the text content and metadata contained within any portion of a text field of an SMS message against at least a portion of the SMS message information of a test case configuration, a stored test case configuration from a test database configured to store and provide testing information, the testing information comprising at least a test configuration, each test case configuration comprising at least a plurality of SMS message information and an execution configuration, the plurality of SMS message information comprising at least a selection of message text content;
analyzing a subset of each of the text content and metadata contained within any portion of a text field of an SMS message;
comparing at least a portion of results of the analysis against the stored test case configuration;
determining execution results comprising information pertaining to whether a test executed successfully as well as information identifying a test case with which the test was associated, the execution results being based on the comparison; and
storing message delivery results in the test database, the message delivery results comprising the results of comparison and a plurality of message delivery metrics comprising at least delivery timing.

6. The method of claim 5, further comprising the steps of:
directing the operation of the messaging server based at least in part on the test case configuration;
producing an SMS response using the messaging server; and
transmitting the SMS response to an SMS gateway via a network.

7. The method of claim 6, wherein operation continues in an iterative fashion to test two-way communication using multiple messages and responses.
